(19) United States
(12) Patent Application Publication
(10) Pub. No.: US 2025/0328023 A1
(43) Pub. Date: Oct. 23, 2025

(54) SECUREMENT BAND FOR A HEAD MOUNTABLE DEVICE

(71) Applicant: Apple Inc., Cupertino, CA (US)

(72) Inventors: Adam Y. Kollgaard, Bainbridge Island, WA (US); Phil M. Hobson, Menlo Park, CA (US); Barry D. Curtin, Seattle, WA (US); Ivan S. Maric, Campbell, CA (US); Shannon Pomeroy, San Francisco, CA (US)

(21) Appl. No.: 18/953,560

(22) Filed: Nov. 20, 2024

Related U.S. Application Data
(60) Provisional application No. 63/636,013, filed on Apr. 18, 2024.

(51) Int. Cl. G02B 27/01

(52) U.S. Cl. CPC G02B 27/0176; G02B 2027/0152

(57) ABSTRACT

A head-mountable device can include a display portion, a light seal extending from the display portion, and an adjustable tension band coupled to the light seal at a first end and a second end opposite the first end. The light seal can be disposed between the display portion and the first and second ends. The display portion can include a rigid housing and a rigid frame, and the light seal can be coupled to the housing or the frame.

### CROSS-REFERENCE TO RELATED APPLICATION

This application claims the benefit of U.S. Provisional Patent Application No. 63/636,013, filed 18 Apr. 2024, and entitled “SECUREMENT BAND FOR A HEAD MOUNTABLE DEVICE,” the entire disclosure of which is hereby incorporated by reference.

### FIELD

The described embodiments relate generally to head-mountable devices. More particularly, the present embodiments relate to facial interfaces and bands for use in head-mountable devices.

### BACKGROUND

Recent advances in portable computing have enabled head-mountable devices that provide augmented reality and virtual reality (AR/VR) experiences to users. Such head-mountable devices can include various components such as a display, a viewing frame, lenses, optical components, a battery, motors, speakers, and other components. These components can operate together to provide an immersive user experience. In particular, head mountable-devices can include components that help provide a distraction-free setting by at least partially blocking or sealing out ambient light from the external environment. This can be a challenging design aspect as users of head-mountable devices have different head sizes, head shapes, and contours of facial features. Therefore, there is a need for a head-mountable device with a lightweight and highly conformable facial interface.

### SUMMARY

In at least one example of the present disclosure, a head-mountable device can include a display, a conformable light seal extending from the display, and an adjustable tension band coupled to the light seal at a first end and a second end opposite the first end. In some examples, the light seal can be disposed between the display and the first and second ends. In some examples, the display can include a rigid housing and a rigid frame, and the light seal can be coupled to the display. In some examples, the light seal can include a compliant material configured to conform to the shape of a user's face. In some examples, the adjustable tension band can include a conformable flexible material.

In at least one example, the head-mountable device can include a tensioner, and the first end is coupled to the light seal via the tensioner. In some examples, the tensioner can include a cable disposed within the light seal and extending from the light seal to the adjustable tension band. In some examples, the tensioner can be a first tensioner including a first cable connecting the first end to the light seal, and the head-mountable device can include a second tensioner including a second cable connecting the second end to the light seal. In some examples, the tensioner can include a continuous loop extending through the light seal and between the first end and the second end. In some examples, the tensioner can include a first cable coupling the first end to the light seal and a second cable coupling the first end to the light seal. In some examples, the light seal can include a first segment and a second segment, the tensioner can include a cable extending along or through the first segment and the second segment, and an adjustment of the tensioner causes the first segment to rotate relative to the second segment.

In at least one example, a wearable electronic display device can include a display. The display can include a housing, a frame, and a display secured to the housing. In some examples, a facial seal can extend from the display and be coupled to the housing or the frame, a securement band can be configured to secure the light seal against a user's face, and an adjustable tensioner can couple the securement band to the light seal. In some examples, the adjustable tensioner can be configured to be manually adjusted. In some examples, the adjustable tensioner can include a dial and a cable coupled to the dial, and a rotation of the dial changes a length of the cable extending through the facial seal. In some examples, the adjustable tensioner can be configured to be automatically adjusted. In some examples, the adjustable tensioner can include a linear actuator. In some examples, the band and the light seal can form a continuous surface configured to wrap around a user's head when donning the wearable electronic display device.

In at least one example, a wearable display device can include a display, a facial interface coupled to the display, and a securement assembly. In some examples, the securement assembly can include an adjustable tensioner, a flexible band coupled to the facial interface via the adjustable tensioner, and a rigid strap extending from the flexible band and coupled to the display. In some examples, the facial interface can define an adjustable depth between the display and a face of a user donning the wearable display device, and the depth can be adjusted independent of an adjustment of the tensioner. In some examples, the rigid strap can include at least one of a processor or a speaker. In some examples, the flexible band can be removably coupled to the rigid strap and the facial interface can be removably coupled to the display. In some examples, the adjustable tensioner can include a webbing.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top view of an example of a head-mountable device;

FIG. 2A shows a top view of another example of a head-mountable device on the head of user in a first configuration;

FIG. 2B shows a top view of another example of a head-mountable device on the head of a user in a second configuration;

FIG. 3A shows a side view of an example of one configuration of a head-mountable device including a tensioner on the head of a user;

FIG. 3B shows a side view of another example of another configuration of a head-mountable device with a tensioner on the head of a user;

FIG. 4 shows a perspective view of an example of a head-mountable device;

FIG. 5 shows an example of a tension system for use in a head-mountable device;

FIG. 6 shows a top view of another example of a head-mountable device;

FIG. 7A shows a top view of an example of a head mountable device including an adjustable facial interface; and

FIG. 7B shows a top view of another example of a head-mountable device including an adjustable facial interface.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates generally to electronic devices, specifically a head-mountable electronic device. In at least one example, a head-mountable device can include a display portion, a light seal extending from the display portion, and an adjustable-tension band coupled directly to the light seal at either end of the band. The display portion can include a rigid housing and one or more displays configured to project light toward a user's eyes when donning the device. The light seal can include a compliant, flexible interface between the display portion and the user's face during use. The light seal can function to seal off the displays and the user's eyes to prevent or reduce ambient light from reaching the user's eyes. In order to do so, the light seals described herein can be configured to conform to a variety of user head and face anatomies, dimensions, and features.

In order to press the light seal against the user's face around the eyes sufficiently to block ambient light, the adjustable-tension band, as noted above, can be directly coupled to the light seal such that when the user tightens the band to secure the device to the user's head, the light seal is pulled against the user's face. This direct connection between the band and the light seal can pull the light seal against the user's face even at certain areas which are harder to conform to, including the user's temple area located laterally outward from the eyes.

Because of the direct connection between the band and the light seal, the light seal can be configured to conform to a variety of user's facial features, dimensions, and sizes without the need to manufacture multiple SKUs of light seals to accommodate different users. The tensioning of the band conforming the light seal to the user's face creates an easy to use, consistent fit for users of having unique facial sizes, dimensions, and shapes.

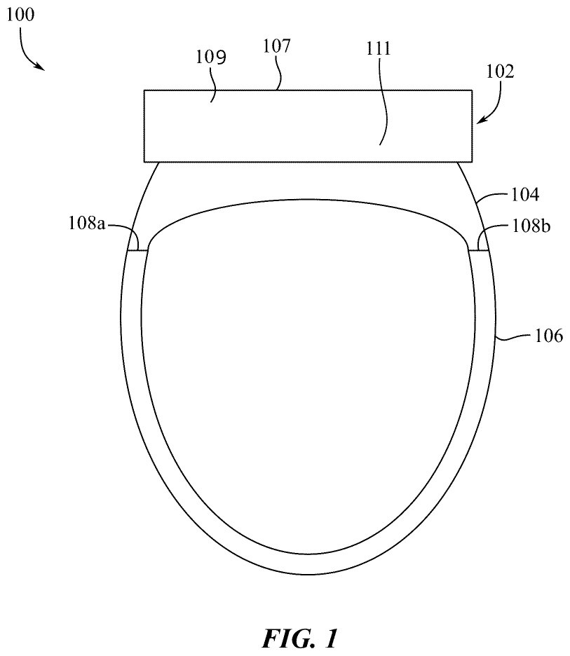

These and other embodiments are discussed below with reference to FIGS. 1-7B. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 shows a top view of a head-mountable device 100 including a display portion 102, a facial interface 104, and an adjustable-tension band 106. A head mountable device 100 can be a wearable electronic device. In at least some examples, the display portion 102 can define a housing 107 and a frame 109. A display 111 can be secured to or disposed within the housing 107 or the frame 109. A display 111 can include a screen, a projection surface, or other means of optical display. In some examples, the screen can be a liquid crystal display (LCD), a light emitting diode display (LED), an organic light emitting diode display (OLED), etc. The display 111 can provide the user with an optical experience. For example, the display 111 can show visual media like videos, movies, pictures, or other kinds of visual media.

In some examples, the facial interface 104 can be facial seal. The facial interface 104 can be a conformable, flexible light seal, including conformable, compressible, flexible material, configured to conform to the contours of the user's face when donning the device 100 to block ambient light from the user's eyes. In some examples, the facial interface 104 can be coupled to the housing 107 or frame 109 defined by the display portion 102. The facial interface 104 can be secured using one of a myriad of methods, including but not limited to clips, pressure sensitive adhesives, temperature sensitive adhesives, fasteners, and so forth. The facial interface 104 can extend from the display portion 102 toward the face of a user. In some examples, the facial interface 104 can be a light seal. The facial interface 104 can prevent or minimize ambient light from entering the view of a user while the head-mountable device 100 is donned. Limited ambient light or the absence of ambient light entering the view of a user while wearing the head-mountable device 100 can minimize distractions while the head-mountable device 100 is donned. Limited ambient light or the absence of ambient light entering the view of a user while the head-mountable device 100 is donned can also allow the eyes of a user to better adjust to low light levels, thus improving the view of visual media displayed by the display portion 102.

In some examples, the adjustable-tension band 106 can form a strap or securement band. The adjustable-tension band 106 can be coupled to the facial interface 104. In some examples, the facial interface 104 can be a light seal disposed between the display portion 102 and the adjustable-tension band 106. In at least some examples, the adjustable-tension band 106 can be coupled to the facial interface 104 at a first terminal end 108a and a second terminal end 108b. The first terminal end 108a can be opposite the second terminal end 108b. In some examples, the tension band 106 can include conformable, flexible material configured to secure the head-mountable device 100 to the head of a user. In some examples, the adjustable-tension band 106 can exert an inward pressure on the head of a user that results in a frictional force that prevents the head-mountable device 100 from sliding or otherwise displacing relative to the head of the user. The adjustable-tension band 106 can be configured to secure the facial interface 104 to the face of a user. A head-mountable device 100 that is stable or a head mountable device with a secure facial interface 104 can help produce a better user experience by preventing light from entering the view of a user. Additionally, a stable head-mountable device 100 can reduce shaking or distortion of the display portion 102. In at least some examples, the adjustable-tension band 106 can be adjustable.

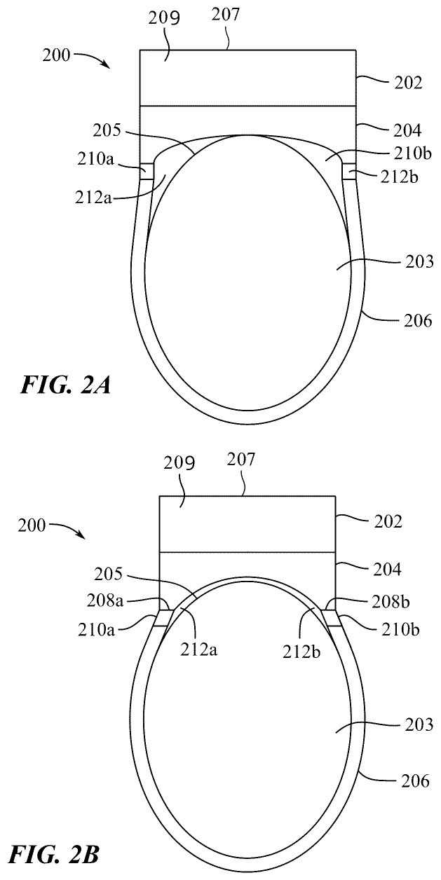

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. Adjustable tension bands are discussed in more depth in FIGS. 2A-2B.

FIG. 2A shows a top view of a head-mountable device 200 donned by a user before adjustment. The head-mountable device 200 can include a display portion 202, a facial interface 204, and an adjustable-tension band 206. The display portion 202 can define a rigid housing 207 and a rigid frame 209. In some examples, the facial interface 204 can be coupled to the rigid housing 207 or rigid frame 209 by any of the attachment methods detailed in reference to FIG. 1. The adjustable-tension band 206 can be secured to the facial interface 204 via at least one tensioner 210a-b. In some examples, tensioner 210a can be opposite tensioner 210b. The adjustable-tension band 206 can be manufactured from one or more flexible materials such that the adjustable-tension band 206 can conform to the head-shape of a user. In some examples, the facial interface 204 can also be manufactured to have various properties such as to accommodate a user's specific head shape, head size, and facial contours. The facial interface 204 can be manufactured from a variety of materials. In at least some examples, the facial interface 204 can be manufactured from one or more compliant materials. Compliant materials can include, but are not limited to, rubber, silicone, textiles, vinyl, foam, polymers, etc. The use of compliant materials in the construction of the facial interface 204 can allow the facial interface 204 to conform to the shape of a user's face.

As shown in FIG. 2A, before the user adjusts the facial interface 204, the facial interface can be in a resting shape or configuration, which, along with the tensioners 210a-b and adjustable-tension band 206, can initially form gaps 212a-b between the user's head 203 and the facial interface 204. The head-mountable device 200 can be configured to adjust the facial interface 212a-b to eliminate the gaps 212a-b and block ambient light from being seen by the user, as shown in FIG. 2B. In at least one example, the tensioners 210a-b can be configured to adjust the tension in the adjustable-tension band 206. By adjusting the tension in the adjustable-tension band 206, the adjustable-tension band 206 can exert a force on one or more terminal ends 208a-b connected to the facial interface 204.

As shown in FIG. 2B, exertion of force on the facial interface 204 by the adjustable-tension band 206 can cause the facial interface 204 to form a seal with the face 205 of a user. FIG. 2B shows the head-mountable device shown in FIG. 2A, with the tensioners 10a-b adjusted to reduce or eliminate gaps 212a-b between the facial interface 204 and the face 205 of a user. In some examples, the compliant nature of the facial interface 204 can allow the facial interface 204 to stretch or deform in response to tension applied by the one or more tensioners 10a-b. Tightening of the tensioners 210a-b can reduce or eliminate the gaps 212a-b. The facial interface 204 can be configured to conform to a variety of face shapes and head shapes of different users.

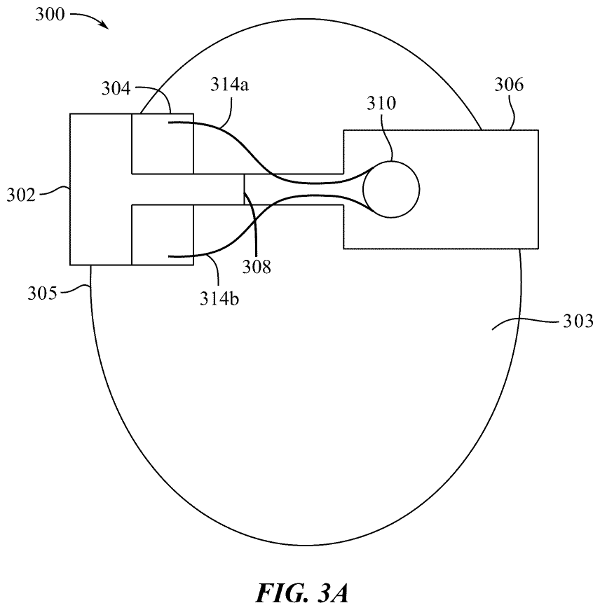

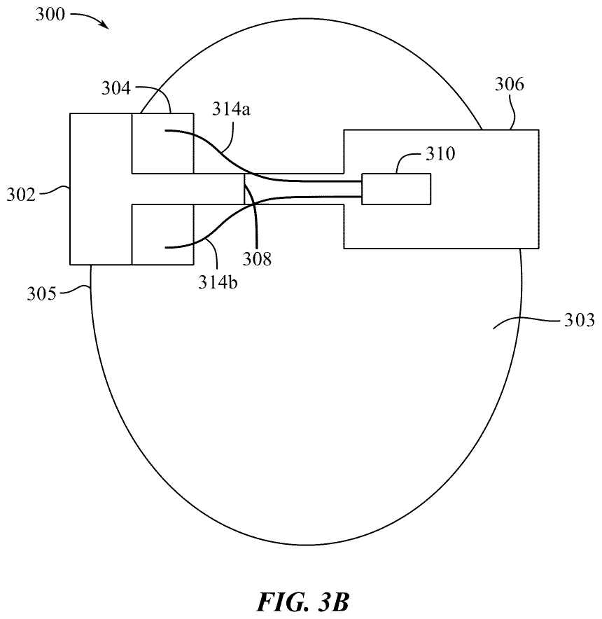

Any of the features, components, and/or parts, including the arrangements and configurations thereof shown in FIGS. 2A-2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2A-2B. More systems, devices, and methods of applying tension are discussed below in reference to FIGS. 3A-B.

FIG. 3A shows an example of a head-mountable device 300, including a display portion 302, a facial interface 304, and a securement band 306. The securement band can be configured to produce tension, holding the head-mountable device to the head 303 of a user. Tension in the securement band 306 and the facial interface 304 can be adjusted in a variety of ways. As shown in FIG. 3A, the head-mountable device 300 can include a first cable 314a and a second cable 314b. The cables 314a-b can be coupled to the facial interface 304 as well as a first tensioner 310. The cables 314a-b can be routed from the first tensioner 310, through the facial interface 304, and to a second tensioner (not shown) opposite the first tensioner 310. In some examples, the head-mountable device 300 can include more than two cables 314a-b. In at least some examples, the cables 314a-b can enter the facial interface 304, the securement band 06, or the display portion 302 via eyelets, slits, grommets, or another method. The openings in the display portion 302, the facial interface 304, or the securement band 306 can be reinforced to increase durability and longevity of the head-mountable device 300

In at least some examples, the cables 314a-b can be at least partially disposed within or on the facial interface 304. The cables 314a-b can also be partially disposed within the securement band 306 or the display portion 302. In some examples, the facial interface 304 can be a light seal. In some examples, the securement band 306 can be an adjustable-tension band. In some examples, the one or more of the cables 314a-b can be disposed within the light seal and extend from the light seal to the adjustable-tension band. In some examples, the cables 314a-b can be at least partially concealed from the view of a user. The cables 314a-b can extend from the at least one tensioner 310, through a portion of the securement band 306, and into the facial interface 304. Concealment of the cables 314a-b within the securement band 306 can improve the durability and lifespan of the head-mountable device 300 by protecting the cables 314a-b from damage, degradation, or other factors. For example, protecting the cables 314a-b can prevent degradation of some plastics, composites, and other material caused by ultraviolet light. Concealing the cables 314a-b at least partially within the securement band 306, the facial interface 304, the display portion 302, or a combination thereof can improve the aesthetic qualities of the head-mountable device 300 without restricting the functionality of the system including the at least one tensioner 310 and the cables 314a-b. In some examples, the securement band 306 can include a first end 308. In some examples, first cable 314a can couple the first end 308 to the light seal described above and a second cable 314b can couple the first end 308 to the light seal described above. In some examples, the facial interface 304 can also include molding configured to receive the cables 314a-b. The molding included in the facial interface can provide padding between the cables 314a-b and the face 305 of a user. For example, one or more of the foam, rubber, silicone, or other materials used in the manufacturing of the facial interface 304 can distribute the force produced by the cables 314a-b such that facial interface 304 provides substantially uniform pressure to the face 305 of a user. Substantially uniform pressure can be more comfortable for a user, especially during extended use of the head-mountable device 300.

In some examples, the one or more tensioners 310 can be manually adjusted. The one or more tensioners 310 can include a dial configured to change the length of the cables 314a-b as the dial is rotated. The possibility of manual adjustment can allow a user to change the tension in the securement band 306 and the facial interface 304, changing the fit and feel of the head-mountable device 300. Manual adjustment can provide a more comfortable experience for the user by allowing the user to change the tightness of the securement band 306 and the facial interface 304. In other examples, the tensioner 310 can control the tension of the cables 314a-b with magnets, clasps, levers, friction-based components, knots, or other methods.

FIG. 3B shows an example of a head-mountable device 300 substantially similar to the head-mountable device 300 shown in FIG. 3A. However, the head-mountable device 300 as shown in FIG. 3B can include a tensioner 310 that is automatically adjustable. In some examples, the tensioner 310 can be configured to tighten the cables 314a-b when the head-mountable device 300 is donned. The tensioner 310 can also be configured to loosen the cables 314a-b when the head-mountable device 300 is doffed. The tensioner 310 can adjust the tension in the cables 314a-b differently in response to being donned by different users. For example, the tensioner 310 can adjust the tension in the cables 314a-b to be tighter in response to being donned by a user with one head size or shape, and can adjust the tension in the cables 314a-b to be looser when donned by a user with a different head size or shape. Additionally, the adjustable tensioner 310 can be configured to make micro-adjustments in response to being worn by a user. In some examples the top cable 314a and the bottom cable 314b can be adjusted separately.

The tensioner 310 can automatically adjust the length or tension of the cables 314a-b via a linear motor, a linear actuator, rotational electric motors, or other electro-mechanical component. As the length of the cables 314a-b is adjusted, the pressure felt on the head 303 by a user can also change. The automatically adjustable tensioner 310 can adjust in response to several different stimuli. In some examples, the head-mountable device 300 can connect wirelessly to a portable electronic device carried by a user such as, but not limited to, mobile devices, wearable electronic devices, tablet computers, or RFID tags. The head-mountable device 300 can store information about a specific user and associate the information with a specific device. When the device is in close proximity to the head-mountable device 300, the automatically adjustable tensioner 310 can configure the cables 314a-b is such a way that is comfortable to the user associated with the device.

In other examples, the automatically adjustable tensioner 310 can include a force sensor. In response to a user donning the head-mountable device 300, the automatically adjustable tensioner 310 can tighten the cables 314a-b to a desired tension. The automation of the tensioning system of the head-mountable device 300 can help provide a more seamless and satisfactory experience to a user. An automatically adjustable tensioner 310 can also minimize down time where the user is changing the tension in the cables 314a-b manually. The use of an automatically adjustable tensioner 310 can also eliminate the need for a portion of the tensioner to be exposed. An automatically adjustable tensioner can be completely concealed within the display portion 302, the facial interface 304, the securement band 306, or a combination thereof. Concealment of the tensioner 310 can help improve the aesthetic and tactile qualities of the head-mountable device 300.

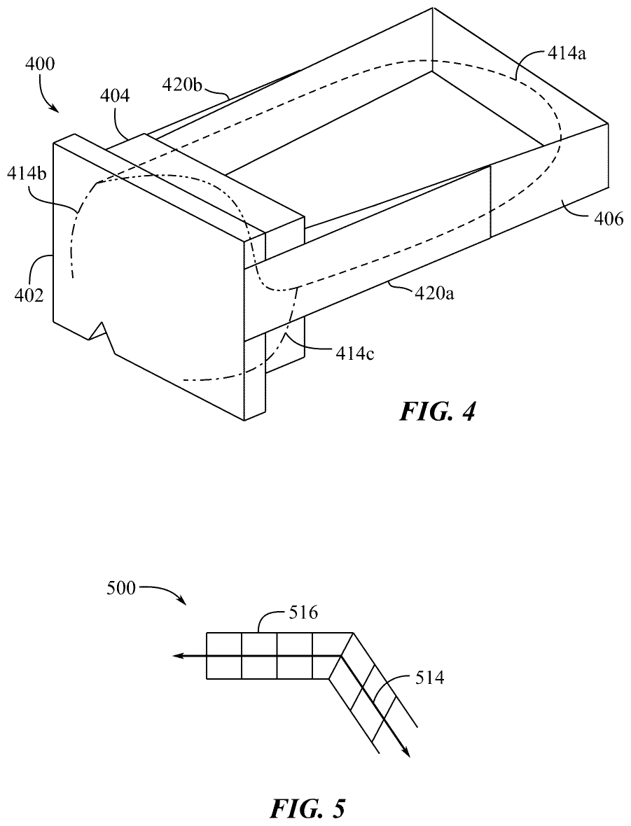

Any of the features, components, and/or parts, including the arrangements and configurations thereof shown in FIG. 3A-3B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3A-3B. Tensioners and tension systems for use in head-mountable devices are discussed in more detail below with reference to FIG. 4.

FIG. 4 shows a perspective view of a head-mountable device 400 including a display portion 402, a facial interface 404, and a securement band 406. In some examples, the head-mountable device 400 can be a wearable display device. The head-mountable device 400 also includes one or more rigid straps 420a-b. The rigid straps 420a-b can extend from the flexible band 406 and can be coupled to the display portion 402. In some examples, the flexible band 406 can be removably coupled to the rigid straps 420a-b. In some examples, the rigid straps 420a-b can include electronic components such as speakers, processors, electrical connectors, cables, or other electronic components. In some examples, the flexible band 406 can be removably coupled to the rigid straps 420a-b and the facial interface 404 can be removably coupled to the display portion 402 such that the flexible band 406 and the facial interface 404 can be decoupled together from the rigid straps 420a-b and the display portion 402. The head-mountable device 400 can also include one or more tensioners. The tensioners can include one or more cables 414a-c. The cables 414a-c can be at least partially disposed within components of the head-mountable device 400 such as the display portion 402, the facial interface 404, the securement band 406, and the rigid straps 420a-b. In some examples, the cables 414a-c can be coupled to the facial interface 404 at a first end and a second end of the facial interface 404. In some examples, the cables 414a-c can enable a direct connection between the securement band 406 and the facial interface 404. In similar or other examples, the securement band 406 can be directly connected to the facial interface 404. For example, the securement band 406 can be attached to the facial interface 404 via pressure sensitive adhesives, temperature sensitive adhesives, clips, fasteners, or other methods.

In at least some examples, the tensioner can include a continuous cable loop. The continuous loop can include cables 414a-c that extend along the securement band 406, and through at least one of the facial interface 404 and the display portion 402. The continuous loop can also extend through the facial interface 404 between a first terminal end and a second terminal end of the facial interface 404. The use of a continuous loop can remove stress and strain from components such as the display portion 402, the facial interface 404, and the securement band 406. For example, attachment points between the cables 414a-c and other components of the head-mountable device 400 can transfer force from the cables 414a-c to the other components. Over time, the forces exerted on the components of the head-mountable device 400 can cause the components to tear, the connections to separate, or the material to break. With the use of a continuous loop, the cables 414a-c do not transfer any point loads to the head-mountable device 400, and therefore extend the life of the device.

In some examples, the adjustable tensioner can include a webbing. A webbing can include a structure that distributes force evenly onto the face of a user. For example, the cables 414a-c can be coupled to a webbing. The cables 414a-c can transfer a tensile force to the webbing, and the webbing can distribute the tensile force as a uniform pressure across the face of a user or a portion of the face of a user. Uniform pressure across the face of a user or a portion of a face of a user can help facilitate a more comfortable experience for the user. For example, the use of a webbing can prevent the user from feeling the cables 414a-c. The webbing can also distribute forces more evenly across facial features such as the forehead, nose, cheek bones, etc. The webbing can ensure that certain facial features are not subject to pressure, such as the eyes. For example, the webbing can include holes or cutouts disposed over some facial features of a user. The cutouts can reduce localized pressure, therefore facilitating a comfortable user experience. The webbing can be manufactured from a variety of materials such as textiles, silicone, rubber, polymers, or other materials.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4. Tension systems, cables, and facial interfaces are further discussed below with reference to FIG. 5.

FIG. 5 shows a tension system 500 for use in a head-mountable device. The tension system 500 can help govern the static forces, pressures, and shape of a head-mountable device. In some examples, the facial interface 404 shown in FIG. 4 can include a plurality of segments 516. The tension system 500 can also include a cable 514 that extends along or through the plurality of segments 516. The cable 514 can be secured or coupled to various components of a head-mountable device as discussed in reference to FIG. 4. The plurality of segments 516 can be configured to rotate in response to a change in length of the cable 514. In other examples, the segments 516 can be configured to rotate in response to a change in force in the cable 514. In some examples, an adjustment of the tensioner 310 described in reference to FIGS. 3A-3B can cause adjacent segments 516 of the plurality of segments 516 to rotate relative to one another. For example, a change in length in the cable 514 can cause each segment 516 of the plurality of segments 516 to rotate to align with a decreased radius of the cable 514.

Rotation of the plurality of segments 516 can cause the segments 516 to exert a normal force on one another, thus increasing the frictional force felt between the segments 516. An increased frictional force between the segments 516 can prevent further constriction of the cable 514, helping to improve comfort. The normal force between segments 516 can also help control the shape and force of the cable 514. For example, a greater normal force between segments can increase the resistance to tensile force exerted on and by the cable 514. The plurality of segments 516 can also provide padding for the cable 514. The segments 516 can be disposed within the facial interface 404 described in FIG. 4 and can help distribute the force exerted by the cables 514 on the face of a user. Distribution of the forces exerted by the cable 514 across a wider area can decrease the pressure felt by a user and therefore improve the comfort and wearability of a head-mountable device. In some examples, increased comfort felt by a user can increase the amount of time a user can wear a head-mountable device. This can allow a user to watch long-form visual media, movies, play games, or otherwise user the device for longer.

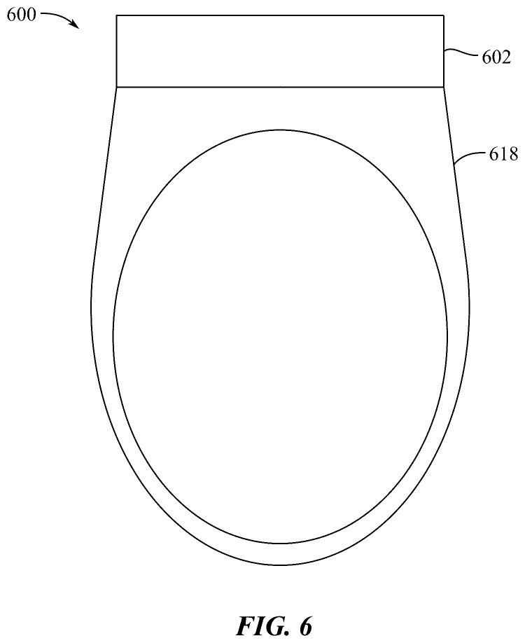

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5. More examples of facial interfaces, securement straps, and attachment methods are discussed below in reference to FIG. 6.

FIG. 6 shows an example of a head-mountable device 600 including a display portion 602 and a securement portion 618. In some examples, the securement portion 618 can be a single component that both interfaces with the face of a user and secures the head-mountable device 600 to the head of a user. In this way, the continuous piece having a continuous surface and forming the securement portion 618 can function as both the facial interface 404 and the securement band 406 described with reference to FIG. 4. In some examples, the continuous piece 618 can be configured to wrap around a user's head when donning the wearable electronic display device. In some examples, the securement portion 618 can be manufactured from one or more substantially static materials such as some polymers, textiles, or other materials. In other examples, the securement portion 618 can be manufactured from materials capable of elastic deformation, such as some textiles, polymers, rubbers, silicones, and other materials. In yet other examples, the securement portion 618 can be manufactured from a combination of static and elastic materials including, but not limited to, the materials listed above. In some examples, the securement portion can include tension members disposed within or on the securement portion 618. In some examples, the tension members included in the securement portion 618 can include cables, webbing, or other components.

In at least some examples, a single securement portion 618 that performs multiple functions can decrease manufacturing costs. For example, the use of fewer parts requires less labor for assembly. The use of a single securement portion 618 that performs multiple functions can also decrease the amount of tools or molds used in the manufacturing process, further reducing costs. A single securement portion 618 that replaces separate facial interfaces and securement bands can also improve the aesthetic qualities of the head-mountable device 600. For example, a securement portion 618 can eliminate the need for attachment points between a facial interface and a securement band or strap. This can help produce clean product lines and a more visually pleasing head-mountable device 600.

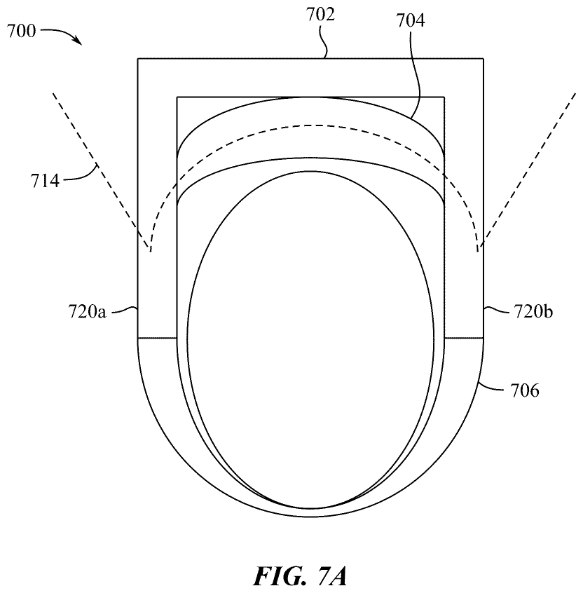

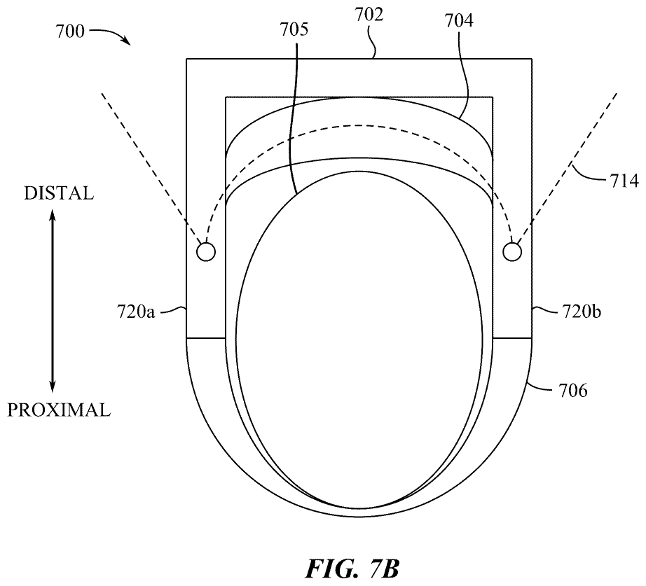

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5. Examples of head-mountable devices with additional adjustability with regard to the facial interfaces and display portions are discussed below with respect to FIGS. 7A-7B.

FIGS. 7A-7B show examples of head-mountable devices 700 with facial interfaces 704 adjustable relative to display portions 702. Facial interfaces that are adjustable relative to display portions can facilitate control of the depth of the display portion 702 relative to the facial interface 704. The facial interface 704 abuts the face 705 of a user, and therefore adjustment of the facial interface 704 relative to the display portion 702 also adjusts the depth between the display portion 702 and the face 705 of a user. Adjustment of the facial interface 704 relative to the display portion 702 can allow a user to set the depth of the display included in the display portion 702 to a comfortable and readable position relative to the face 705 of a user. Changing the depth between the display portion 702 and the face 705 of a user can help the eyes of a user focus on the media displayed by the head-mountable device 700. For example, an increased depth between the facial interface 704 and the display portion 702 can allow for the use of corrective lenses. Increased or decreased depth between the facial interface 704 and the display portion 702 can also help accommodate users who are near-sighted or far-sighted. Additionally, the depth between the facial interface 704 and the display portion 702 can improve airflow and breathability of the head-mountable device 700.

FIG. 7A shows head-mountable devices with a display portion 702, a facial interface 704, and a flexible band 706. The facial interface 704 can also be removably coupled to the display portion 702. The head-mountable device 700 also includes one or more rigid straps 720a-b. The rigid straps 720a-b can extend from the flexible band 706 to the display portion 702. In some examples, the flexible band 706 can be removably coupled to the rigid straps 720a-b. In some examples, the rigid straps 720a-b can include electronic components such as speakers, processors, electrical connectors, cables, or other electronic components. The head-mountable device 700 also shows an adjustable tensioner 714. The adjustment tensioner 714 can extend through one or more of the rigid straps 720a-b and through the facial interface 704. In the example shown in FIG. 7A, the length of the adjustable tensioner 714 determines the depth of the display portion 702 relative to the facial interface 704. For example, the display portion 702 can be at one depth relative to the facial interface 704 when the adjustable tensioner 714 is at a first length. When the adjustable tensioner 714 is at a second length shorter than the first length, the display portion 702 can be at a shallower depth relative to the facial interface 704. In the example shown in FIG. 7A, the adjustable tensioners 714 can be secured to the rigid straps 720a-b at a fixed position.

FIG. 7B shows a head-mountable device 700 including a display portion 702, a facial interface 704, a flexible band 706, rigid straps 720a-b, and an adjustable tensioner 714 substantially similar to the head-mountable device 700 shown in FIG. 7A. However, in FIG. 7B, the adjustable tensioner 716 is slidably coupled to the rigid straps 720a-b. This can allow the depth of the display portion 702 to be adjusted relative to the facial interface 704 by translating the attachment points of the adjustable tensioner 714 relative to the rigid straps 720a-b. In some examples, the facial interface 704 can define an adjustable depth between the display portion 702 and a face 705 of a user donning the wearable display device 700. In some examples, the depth can be adjusted independent of an adjustment of the adjustable tensioners 714.

Any of the features, components, and/or parts, including the arrangements and configurations thereof shown in FIG. 7A-7B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7A-7B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A head-mountable device, comprising:
a display;
a conformable light seal extending from the display; and
an adjustable-tension band coupled to the light seal at a first end of the adjustable-tension band and a second end of the adjustable-tension band opposite the first end;
wherein the light seal is disposed between the display and the first and second ends.

2. The head-mountable device of claim 1, wherein:
the display comprises a rigid housing and a rigid frame; and
the light seal is coupled to the display, the light seal comprising a compliant material configured to conform to a shape of a user's face.

3. The head-mountable device of claim 2, wherein the adjustable-tension band comprises a conformable flexible material.

4. The head-mountable device of claim 1, wherein:
the head-mountable device further comprises a tensioner; and
the first end is coupled to the light seal via the tensioner.

5. The head-mountable device of claim 4, wherein the tensioner comprises a cable disposed within the light seal and extending from the light seal to the adjustable-tension band.

6. The head-mountable device of claim 4, wherein:
the tensioner is a first tensioner including a first cable connecting the first end to the light seal; and
the head-mountable device further comprises a second tensioner including a second cable connecting the second end to the light seal.

7. The head-mountable device of claim 4, wherein the tensioner comprises a continuous loop extending through the light seal and between the first end and the second end.

8. The head-mountable device of claim 4, wherein the tensioner comprises:
a first cable coupling the first end to the light seal; and
a second cable coupling the first end to the light seal.

9. The head-mountable device of claim 4, wherein:
the light seal comprises a first segment and a second segment;
the tensioner comprises a cable extending along or through the first segment and the second segment; and
an adjustment of the tensioner causes the first segment to rotate relative to the second segment.

10. A wearable electronic display device, comprising:
a display portion, including:
a housing;
a frame; and
a display secured to the housing;
a facial seal extending from the display portion and coupled to at least one of the housing or the frame;
a securement band configured to secure the facial seal against a user's face; and
an adjustable tensioner coupling the securement band to the facial seal.

11. The wearable electronic display device of claim 10, wherein the adjustable tensioner is configured to be manually adjusted.

12. The wearable electronic display device of claim 11, wherein:
the adjustable tensioner comprises:
a dial; and
a cable coupled to the dial; and
a rotation of the dial changes a length of the cable extending through the facial seal.

13. The wearable electronic display device of claim 10, wherein the adjustable tensioner is configured to be automatically adjusted.

14. The wearable electronic display device of claim 13, wherein the adjustable tensioner comprises a linear actuator.

15. The wearable electronic display device of claim 10, wherein the band and the light seal form a continuous surface configured to wrap around a user's head when donning the wearable electronic display device.

16. A wearable display device, comprising:
a display;
a facial interface coupled to the display;
a securement assembly, comprising:
an adjustable tensioner;
a flexible band coupled to the facial interface via the adjustable tensioner; and
a rigid strap extending from the flexible band and coupled to the display.

17. The wearable display device of claim 16, wherein:
the facial interface defines an adjustable depth between the display and a face of a user donning the wearable display device; and
the depth can be adjusted independent of an adjustment of the tensioner.

18. The wearable display device of claim 16, wherein the rigid strap comprises at least one of a processor or a speaker.

19. The wearable display device of claim 16, wherein the flexible band is removably coupled to the rigid strap and the facial interface is removably coupled to the display.

20. The wearable display device of claim 19, wherein the adjustable tensioner comprises a webbing.
